(19) United States
(12) Patent Application Publication
(10) Pub. No.: US 2026/0187897 A1
(43) Pub. Date: Jul. 2, 2026

(54) SYSTEMS AND METHODS FOR ADJUSTING AN AVATAR MODEL BASED ON COMPUTATIONAL COST

(71) Applicants: Constructor Technology AG, Schaffhausen (CH); Constructor Education and Research Genossenschaft, Schaffhausen (CH)

(72) Inventors: Andrei BOIAROV, Sofia (BG); Alexander Tormasov, Busingen am Hochrhein (DE); Serg Bell, Singapore (SG); Stanislav Protasov, Singapore (SG); Nikolay Dobrovolskiy, Alanya (TR); Laurent Dedenis, Geneve (CH)

(21) Appl. No.: 19/003,972

(22) Filed: Dec. 27, 2024

(51) Int. Cl. G06T 15/00; G06T 13/40; G06T 19/20

(52) U.S. Cl. CPC G06T 15/005; G06T 13/40; G06T 19/20; G06T 2200/16; G06T 2210/36

(57) ABSTRACT

A system generates, for display on a computing device, an avatar based on an avatar model specifying visual characteristics and movement capabilities of the avatar. The system receives a request to reduce computational costs for generating the avatar by a specified amount. The system executes a machine learning model trained to select one or more of the visual characteristics and the movement capabilities of the avatar to adjust based on available computational resources and computational costs to utilize the available computational resources. The system adjusts the one or more of the visual characteristics and the movement capabilities of the avatar outputted by the machine learning model in response to the request.

### FIELD OF TECHNOLOGY

The present disclosure relates to the field of machine learning, and, more specifically, to systems and methods for adjusting an avatar model based on computational cost.

### BACKGROUND

The creation of an avatar, particularly one that is both realistic and interactive, constitutes a complex and computationally demanding endeavor. This complexity stems from the necessity to replicate human-like features and behaviors, which necessitates the use of advanced algorithms and substantial processing power. The process of generating an avatar typically encompasses several stages, including 3D modeling, texture mapping, rigging, and animation. Each of these stages requires precise calculations and the management of large datasets to ensure that the avatar appears and behaves in a lifelike manner.

The initial step, 3D modeling, involves defining the shape and structure of the avatar. This process necessitates detailed geometric calculations to create a mesh that accurately represents the human form. Following this, texture mapping is applied, where surface details such as skin, hair, and clothing are added to the model. This step involves complex algorithms to ensure that textures are applied seamlessly and realistically.

Rigging represents another computationally intensive task, wherein a skeleton is constructed to facilitate the avatar's movement. This involves establishing a system of bones and joints, which must be meticulously calculated to ensure realistic movement. Finally, animation breathes life into the avatar, requiring sophisticated algorithms to simulate natural human motion and expressions.

Furthermore, if the avatar is intended to be interactive, additional computational resources are required to process user inputs and generate real-time responses. This necessitates the integration of artificial intelligence and machine learning techniques, which further augment the computational demands.

It is evident that the generation of an avatar is a resource-intensive task that demands a combination of advanced software, powerful hardware, and skilled technical expertise to achieve a high degree of realism and interactivity. This combination can often be expensive and beyond the budget of a user. To make avatars accessible in casual everyday settings where computational resources are limited or fluctuate, there is a need for a system that adjusts avatars on the fly based on various computational factors and their associated costs.

### SUMMARY

The systems and methods described in the present disclosure are designed to simplify avatars based on the availability of computational (e.g., hardware) resources and their associated costs. More specifically, the system is designed to manage costs and micropayments associated with, for example, CPU/GPU time, RAM capacity, storage, etc.. The system provides users with the ability to predict expenses and adjust the complexity or simplicity of an avatar to align with a specific budget. For example, users may be prompted with the question, “how much money do you want to spend on generating your avatar?”. The user response may trigger a modification of the avatar's parameters, with the system recalculating expenses accordingly. During the avatar's usage, such as in a video call, the system implements a billing process through micropayments for the resources consumed. If the expenses during the call approach a predefined limit or account balance, the system may automatically simplify the avatar's quality to manage costs effectively.

This simplification can be achieved through various optional strategies. These options include reducing active movements and focusing solely on facial and cognitive expressions, such as turning to the side and adopting a thoughtful pose. Additionally, the size of the avatar can be minimized, and the resolution during rendering can be decreased to optimize resource usage.

Utilizing prerecorded videos for gestures is another possibility to ease computational load. Simplification may also involve reducing the level of detail in the avatar's appearance, converting dynamic elements into static ones, and removing reflective layers. A smooth transition to a cartoon-like model is another potential option. Finally, combining geometry likelihood layers, which include both body and appearance, can be considered to enhance resolution and performance, ensuring the avatar remains effective and visually coherent within the specified constraints.

In one exemplary aspect, the techniques described herein relate to a method for adjusting an avatar, the method including: generating, for display on a computing device, an avatar based on an avatar model specifying visual characteristics and movement capabilities of the avatar; receiving a request to reduce computational costs for generating the avatar by a specified amount; executing a machine learning model trained to select one or more of the visual characteristics and the movement capabilities of the avatar to adjust based on available computational resources and computational costs to utilize the available computational resources; and adjusting the one or more of the visual characteristics and the movement capabilities of the avatar outputted by the machine learning model in response to the request.

In some aspects, the techniques described herein relate to a method, wherein the request to reduce the computational costs is for decreasing a total monetary cost to utilize of one or more of: central processing unit (CPU), graphics processing unit (GPU), random access memory (RAM), storage, bandwidth, latency, and validation resources. In some aspects, the total monetary cost is a dynamic value that changes based on one or more of: time of usage, location of usage, and type of provider.

In some aspects, the techniques described herein relate to a method, wherein the machine learning model is trained to identify a bottleneck in avatar generation that has a highest computational cost and perform reduction on the bottleneck.

In some aspects, the techniques described herein relate to a method, wherein the machine learning model is trained on a training dataset including a plurality of input computational cost changes and corresponding avatar adjustments.

In some aspects, the techniques described herein relate to a method, further including: receiving user experience requirements associated with the avatar model; evaluating a quality of avatar generation; and adjusting, based on both the quality of avatar generation and the request, one or more of the visual characteristics and the movement capabilities of the avatar while the avatar is displayed on the computing device.

In some aspects, the techniques described herein relate to a method, wherein evaluating the quality of the avatar generation includes monitoring for user experience feedback generated based on interactions with the avatar.

In some aspects, the techniques described herein relate to a method, wherein evaluating the quality of the avatar generation includes comparing avatar performance against predetermined benchmarks.

In some aspects, the techniques described herein relate to a method, wherein the visual characteristics further include internal characteristics including one or more of: skeleton components and computational characteristics.

In some aspects, the techniques described herein relate to a method, wherein the computational characteristics include one or more of: an amount or size of physical models, Courant number, amount of hairs, amount of textures, amount of polygons.

In some aspects, the techniques described herein relate to a method, wherein adjusting one or more of the visual characteristics and the movement capabilities of the avatar includes performing one or more of: (1) decreasing active movements performed by the avatar, (2) reducing an amount of expressions performed by the avatar, (3) reducing a size of the avatar, (4) decreasing a rendering resolution of the avatar, (5) using prerecorded videos of gestures in place of dynamic animations performed by the avatar, or (6) reducing appearance details on the avatar.

In some aspects, the techniques described herein relate to a method, wherein reducing the appearance details on the avatar includes one or more of: (1) changing dynamic elements of appearance to static, (2) deleting layers with reflections (3) replacing a photo-realistic avatar with a cartoon avatar, or (4) combining geometry likelihood layers.

In some aspects, the techniques described herein relate to a method, further including: receiving a subsequent request to increase the computational costs for generating the avatar by the specified amount; re-adjusting the one or more of the visual characteristics and the movement capabilities of the avatar outputted by the machine learning model in response to the subsequent request.

In some aspects, the techniques described herein relate to a method, wherein re-adjusting includes resetting the one or more of the visual characteristics and the movement capabilities of the avatar outputted by the machine learning model without re-executing the machine learning model in response to determining that the specified amount is a same amount included in the request to reduce the computational costs.

In some aspects, the techniques described herein relate to a method, wherein the computational costs comprise a plurality of predefined weights associated with the computational resources, wherein each respective weight of the plurality of weights is indicative of a fee for utilizing a corresponding computational resource of the computational resources.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for adjusting an avatar, including: at least one memory; and at least one hardware processor coupled with the at least one memory and configured, individually or in combination, to: generate, for display on a computing device, an avatar based on an avatar model specifying visual characteristics and movement capabilities of the avatar; receive a request to reduce computational costs for generating the avatar by a specified amount; execute a machine learning model trained to select one or more of the visual characteristics and the movement capabilities of the avatar to adjust based on available computational resources and computational costs to utilize the available computational resources; and adjust the one or more of the visual characteristics and the movement capabilities of the avatar outputted by the machine learning model in response to the request.

In some aspects, the techniques described herein relate to a non-transitory computer readable medium storing thereon computer executable instructions for adjusting an avatar, including instructions for: generating, for display on a computing device, an avatar based on an avatar model specifying visual characteristics and movement capabilities of the avatar; receiving a request to reduce computational costs for generating the avatar by a specified amount; executing a machine learning model trained to select one or more of the visual characteristics and the movement capabilities of the avatar to adjust based on available computational resources and computational costs to utilize the available computational resources; and adjusting the one or more of the visual characteristics and the movement capabilities of the avatar outputted by the machine learning model in response to the request.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for adjusting an avatar model based on computational cost.

FIG. 2 is a diagram illustrating an example of a simplified visual appearance of an avatar.

FIG. 3 illustrates a block diagram of a specific approach for adjusting an avatar model based on computational cost.

FIG. 4 illustrates a flow diagram of a method for adjusting an avatar model based on computational cost.

FIG. 5 presents an example of a general-purpose computer system on which aspects of the present disclosure can be implemented.

### DETAILED DESCRIPTION

Exemplary aspects are described herein in the context of a system, method, and computer program product for adjusting an avatar model based on computational cost. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

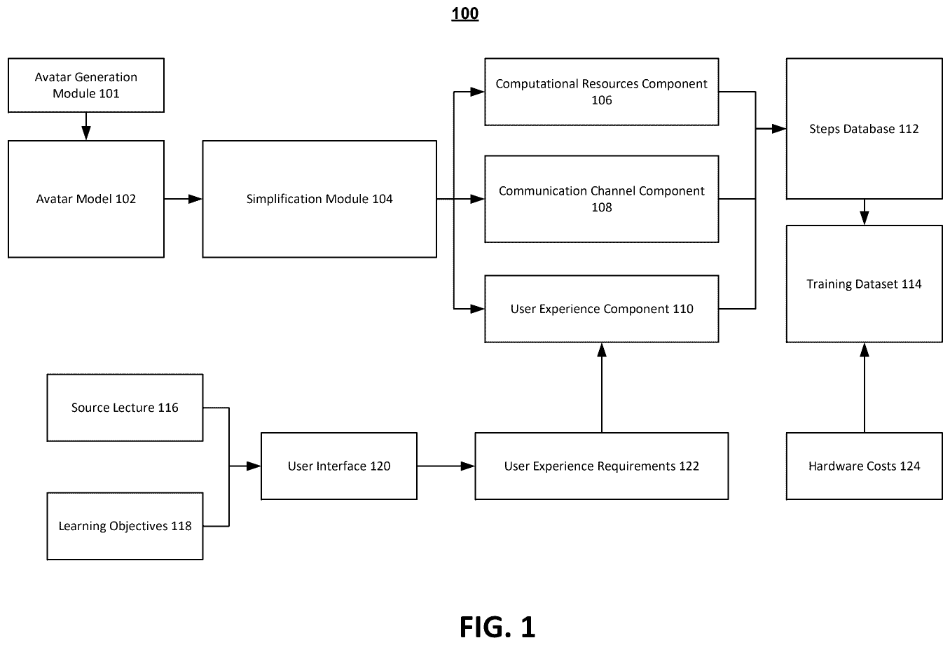

FIG. 1 is a block diagram illustrating system 100 for adjusting an avatar model based on computational cost. In some aspects, system 100 may be implemented using computer system 20 (described in FIG. 6). For example, datasets and databases may be stored in memory 22 and software actions may be executed by processor 21.

In some aspects, system 100 may be implemented across multiple computer systems. For example, one computer system may generate the initial avatar and another computer system may adjust the visual appearance of the avatar during simplification.

Firstly, avatar generation module 101 may generate avatar model 102. The first step in generating an avatar model is 3D modeling, where the basic structure and form of the avatar are created. This involves using software tools that allow designers to sculpt and shape the avatar's body, face, and other features. The software typically used for this purpose includes programs like Blender, Autodesk Maya, or ZBrush. These tools provide a range of functionalities to create detailed and complex models.

Subsequently avatar generation module 101 may be used to perform texture mapping, where surface details such as skin, hair, and clothing are applied to avatar model 102. This process involves creating and applying textures that give the avatar a realistic appearance.

Avatar generation module 101 may then perform rigging, which is the process of creating a skeleton for the avatar, which allows it to move. This involves setting up a system of bones and joints that can be manipulated to animate the avatar.

Avatar generation module 101 may further perform rendering, where the completed model is processed to produce the final image or animation. This step involves complex calculations to simulate lighting, shadows, and other visual effects. Rendering software such as Arnold, V-Ray, or Unreal Engine is used to achieve high-quality results.

Avatar generation module 101 ultimately outputs avatar model 102, which is input into simplification module 104. Avatar model 102 represents the target appearance and movement desired by the user. In an ideal scenario where simplification is not necessary, the avatar should appear and move as captured by avatar model 102. However, because simplification may be needed to account for user preferences and computational resources, simplification module 104 is utilized.

In some aspects, simplification module 104 is made up of various components including computational resources component 106, communication channel component 108, user experience component 110, steps database 112, and training dataset 114.

Computational resources component 106 evaluates the changes in needed computational resources (CPU, GPU, RAM user (client) or owner (server)). For example, if a first set of computational resources are needed to generate avatar model 102, but only a second set of computational resources are available, computational resources component 106 will detect the discrepancy.

Communication channel component 108 evaluates the changes in the needed communication channel (broadband).

User experience component 110 evaluates for changes in user experience. For example, suppose that avatar model 102 is configured to present source lecture 116. For example, the avatar may be a teaching avatar powered using artificial intelligence. The avatar may recite course subject matter to a class and field questions from students and provide answers. In this case, various algorithms may propel the avatar such as a large language model. Learning objectives 118 indicate the goal(s) of the course (i.e., what the students should learn). User interface 120 may be used by the students to evaluate the avatar and provide user experience requirements 122. For example, students may fill out a survey that requests the improvements they would like to see in the avatar. Students may indicate that they would like longer responses with more examples, a greater variety of gestures, a greater variety of expressions, etc. User experience component 110 may quantify the user experience requirements 122 and help adjust avatar model 102. For example, if a simplification step possibility involves reducing the number of gestures, but students wish for the avatar to be more expressive, that specific simplification step may not be implemented.

The list of simplification options for simplification module 104 to user may be stored in steps database 112. Steps database 112 may highlight the steps and consequences for changes in computational recourses, communication channels, and user experience. For example, improvement in said categories may lead to the generation of an avatar that closer resembles avatar model 102, whereas worsening in said categories may lead to a greater degree of simplification.

Examples of simplification include, but are not limited to, reducing active movements and focusing solely on facial and cognitive expressions, such as turning to the side and adopting a thoughtful pose. Additionally, the size of the avatar in pixels on the screen can be minimized, and the resolution during rendering can be decreased to optimize resource usage.

Utilizing prerecorded videos for gestures is another possibility to ease computational load. Simplification may also involve reducing the level of detail in the avatar's appearance, converting dynamic elements into static ones, and removing reflective layers. A smooth transition to a cartoon-like model is another potential option. Finally, combining geometry likelihood layers, which include both body and appearance, can be considered to enhance resolution and performance, ensuring the avatar remains effective and visually coherent within the specified constraints.

Training dataset 114 captures a plurality of specific examples indicative of detected changes and the corresponding technical steps to take for simplification. These examples are highly specific. For example, if there is an increase in CPU usage by X% and no change in communication channel or user experience, a training data point may indicate that the number of gestures performed by the avatar should be decreased by Y%. Training dataset 114 may be used to train a regression model of simplification module 104.

Training dataset 114 further captures hardware costs 124. The cost of hardware including, but not limited to, a Central Processing Unit (CPU), Graphics Processing Unit (GPU), and Random Access Memory (RAM) plays a pivotal role in shaping the generation and performance of virtual avatars, especially in domains like gaming, virtual reality, and simulations.

Consider a cloud computations platform that charges fees for the use of computational devices, offering a diverse range of configurations tailored to meet various user needs. This platform provides users with the flexibility to select from a variety of CPUs, GPUs, and other computational resources, each with distinct performance capabilities and associated costs. For instance, a user might choose a high-performance GPU configuration for intensive tasks such as machine learning or data analysis, which would incur higher fees compared to a basic CPU setup suitable for less demanding applications. Each configuration is priced according to the resources it utilizes, allowing users to optimize their expenditure based on their specific computational requirements. This pricing model not only ensures that users pay for exactly what they need but also encourages efficient resource utilization by offering scalable options that can be adjusted as project demands evolve.

Suppose that the configurations of the cloud computations platform are used to execute the generation of an avatar. The following is a breakdown of how various hardware components may influence the generation. The CPU executes instructions and manages system operations. In the realm of virtual avatars, the CPU is responsible for handling logic, physics calculations, and artificial intelligence (AI) behaviors that dictate how an avatar interacts with its environment and other entities. A powerful CPU can process complex algorithms, enabling sophisticated behaviors and interactions for avatars, but will be costlier than a weaker CPU.

For instance, an avatar in a course setting may possess advanced AI, allowing it to learn from student actions and adapt its teaching strategies in real-time, which demands significant computational power. However, if the CPU is less powerful due to budget constraints, simplification of the avatar's AI and interactions may be needed, reducing the number of simultaneous actions an avatar can perform or limiting the complexity of its decision-making processes. Instead of dynamically adapting to student performance and questions in an in-class setting, an avatar may instead follow a set of pre-defined patterns. In some aspects, use of the CPU may be charged at a fixed rate (e.g., $300 for one-time use) or by time (e.g., $0.20 per minute).

The GPU is specialized for rendering images and handling complex graphics tasks, crucial for generating the visual aspects of virtual avatars, including textures, lighting, and animations. A high-end GPU can render detailed textures, realistic lighting, and smooth animations, contributing to a lifelike appearance of avatars. For example, in a virtual reality application, a powerful GPU can create highly detailed avatars with realistic skin textures and fluid movements, enhancing immersion. Conversely, with a lower-cost GPU, simplification module 104 may need to reduce the visual fidelity of avatars, using lower-resolution textures, simpler lighting models, or fewer polygons in the avatar's mesh. As a result, the avatar may appear less detailed and more cartoonish, with static or simplified hair models instead of realistic hair physics.

RAM is essential for storing and quickly accessing data that the CPU and GPU need to perform their tasks. RAM affects how much information can be processed simultaneously, impacting the complexity of virtual environments and avatars. Sufficient RAM allows for the storage and quick retrieval of large amounts of data, enabling complex scenes with multiple detailed avatars or animations. The more RAM that is used, the costlier the generation of the avatar.

In higher-cost situations, where budget constraints limit the power of the CPU, GPU, and RAM, trade-offs in the complexity and realism of virtual avatars are necessary. Simplifications may include reducing visual details, limiting AI complexity, or decreasing the number of interactive elements. These adjustments help ensure that the system can run smoothly without exceeding its hardware capabilities, but they can also impact the overall user experience by making avatars and environments less immersive.

In some aspects, a user can request a reduction of cost expenses (e.g., in terms of hardware costs 124) to make room for other software running on a computing device. Accordingly, simplification module 104 may simplify the avatar by reducing the polygon count of the avatar and using lower-resolution textures. This simplification decreases the demand on the GPU and CPU, effectively lowering hardware costs and freeing up resources to ensure smooth operation of both the virtual reality application and the analytics tool. By strategically simplifying the avatar, a balance is maintained between visual quality and overall system performance, allowing for the integration of additional software functionalities without the need for costly hardware upgrades.

To illustrate the execution of an avatar model using a cloud computing platform, consider a scenario where a company wants to deploy a virtual assistant avatar that interacts with users in real-time. The company plans to use a cloud service provider like Amazon Web Services (AWS), Google Cloud Platform (GCP), or Microsoft Azure to host and run their avatar model. The model is designed to process user inputs, generate responses, and render a 3D avatar in real-time. The cloud platform charges based on the computational resources used, such as CPU, GPU, memory, and storage.

Initially, the avatar model is deployed on a virtual machine (VM) in the cloud, which is configured with the necessary CPU and memory to efficiently handle user requests. In this scenario, the company selects a VM equipped with 4 CPUs and 16 GB of RAM, incurring a cost of $0.10 per hour. For real-time processing, the avatar model must process user inputs and generate responses promptly, necessitating low-latency and high-throughput capabilities. This may require additional resources such as a load balancer and auto-scaling to manage varying user loads effectively. For simplicity, it is assumed that the average usage is 10 hours per day, with an additional cost of $0.05 per hour for these resources. User interactions and model data are stored in a cloud database, with storage costs calculated at $0.02 per GB per month. The company uses 100 GB of storage. The cost calculation for these operations includes a deployment cost of $72, calculated as 30 days multiplied by 24 hours per day at $ 0.10 per hour. The real-time processing cost amounts to $45, based on 30 days of 10 hours per day usage at a combined rate of $0.15 per hour for processing and additional resources. The storage cost is $2, derived from 100 GB at $0.02 per GB. Consequently, the total monthly cost for running the avatar model on the cloud is $119, which is the sum of the deployment, processing, and storage costs. As additional users access the avatar model, the costs to run the avatar model will increase.

A user of simplification module 104 may indicate a budget reduction using a user interface of the simplification module. With a budget reduction (e.g., of 10%), simplification module 104 allocates the limited budget across necessary computational resources, such as CPU, GPU, memory, and storage, while maintaining acceptable performance levels. In terms of resource allocation, the company previously used a virtual machine (VM) costing $0.10 per hour. To reduce costs, the module might select a VM with fewer CPUs or less RAM, reducing the hourly cost to, for example, $0.08 per hour. This change would still allow for basic operations but with reduced processing power. Additionally, the module could reduce the number of operational hours from 10 to 8 hours per day, further decreasing costs. For load balancing and auto-scaling, the additional cost was $0.05 per hour. By optimizing the model's efficiency, the module might reduce this to $0.03 per hour, possibly by limiting peak-time operations or using more efficient algorithms. Regarding storage costs, which were $0.02 per GB for 100 GB, the module could compress data or reduce the amount of stored data to 80 GB, lowering the cost to $1.60.

To fit the reduced computational capacity, the avatar model itself must be simplified. For example, simplification module 104 may perform visual quality reduction, where module 104 may lower the resolution of the avatar's textures and reduce the complexity of 3D models. This decreases the GPU load and allows the model to run on less powerful hardware without significant performance degradation. Additionally, animation and feature simplification can be achieved by reducing frame rates or using less complex motion algorithms, which helps maintain responsiveness while using fewer resources. Non-essential features, such as advanced lighting effects or high-detail facial expressions, might be scaled back to conserve processing power.

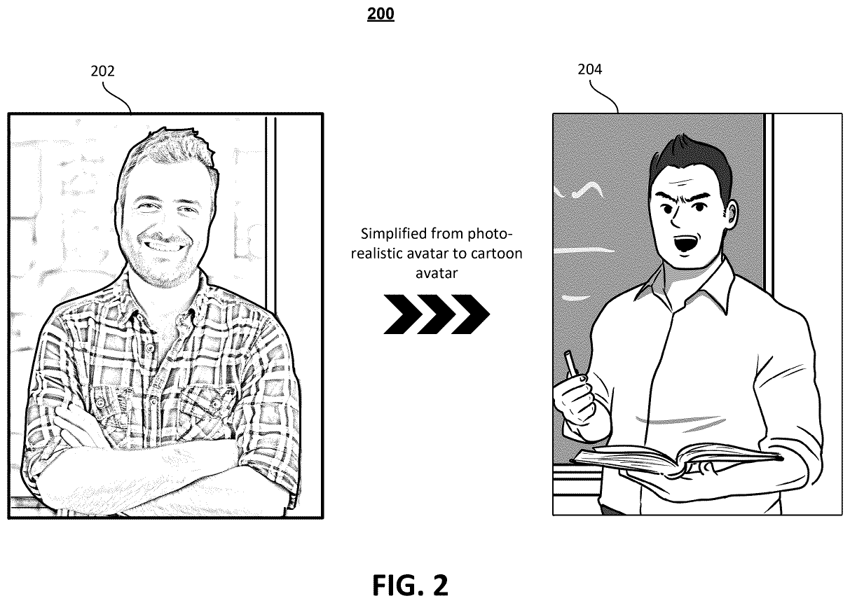

FIG. 2 is a diagram illustrating an example of a simplified visual appearance of an avatar. For example, avatar 202 is a photo-realistic depiction of an avatar as captured by avatar model 102. More specifically, the avatar 202 is a human male wearing a collared shirt with a checkered print. Suppose that simplification module 104 detects a decrease in broadband and other computational resources. Simplification module 104 may simplify the avatar 202 by making a cartoon representation 204 of the avatar. The cartoon representation 204 appears like the human avatar, but several visual details are simplified (no individual hair strands, simplified facial features, more consistent colors, no pattern on the collared shirt).

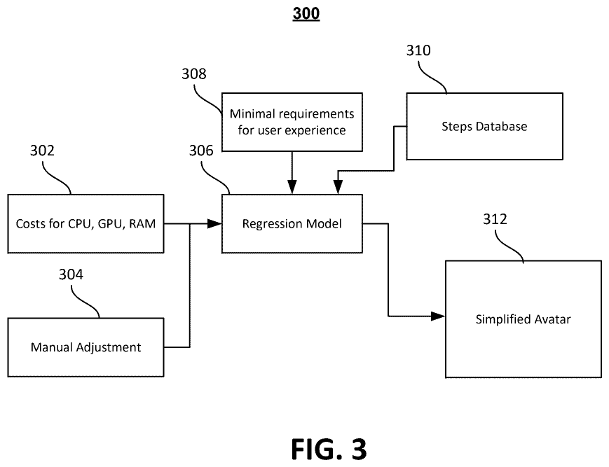

FIG. 3 illustrates a block diagram 300 of a specific approach for adjusting an avatar model based on cost. In diagram 300, regression model 306 receives a plurality of inputs. For example, model 306 receives a breakdown of hardware costs 302. This may be a pricing overview that indicates all available hardware components and their monetary usage costs. Model 306 further receives manual adjustment 304, via a user interface, where adjustment 304 is a user-provided indication of the latest budget change. For example, the user may indicate a drop in budget by 10%.

Model 306 further receives minimal requirements for user experience 308 (e.g., user preferences in avatar performance or benchmarks). Model 306 further has access to steps database 310. This combination of inputs enables model 306 to identify the necessary adjustments to an avatar model, which ultimately yields simplified avatar 312.

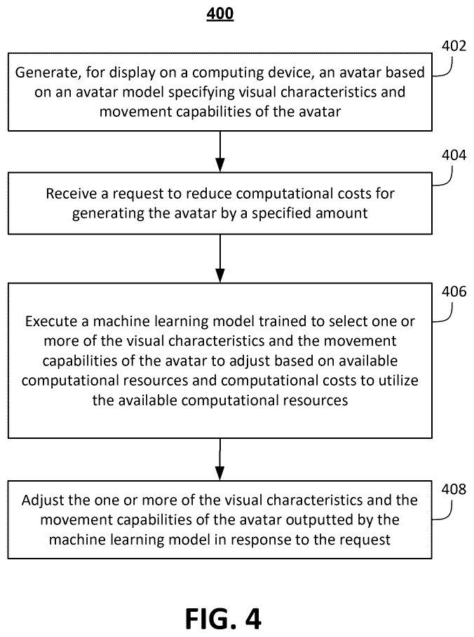

FIG. 4 illustrates a flow diagram of method 400 for adjusting an avatar model based on cost. At 402, simplification module 104 generates, for display on a computing device, an avatar based on an avatar model (e.g., model 102) specifying visual characteristics and movement capabilities of the avatar.

At 404, simplification module 104 receives a request to reduce computational costs for generating the avatar by a specified amount (e.g., manual adjustment 304). In some aspects, the request to reduce the computational costs is for decreasing a total monetary cost to utilize of one or more of: central processing unit (CPU), graphics processing unit (GPU), random access memory (RAM), storage, bandwidth, latency, and validation resources. In some aspects, the total monetary cost is a dynamic value that changes based on one or more of: time of usage, location of usage, and type of provider. For example, costs for using servers may decrease at night (e.g., after 11:00 PM) as compared to daytime usage. Similarly, a user can choose a CPU from a different location (e.g., India) than their current location (e.g., United States). The access to the CPU may have more latency and less reliability, but will be cheaper than a CPU of the same hardware attributes in a location closer to the user. In another example, using a CPU from a first provider (e.g., Google) may have a different cost than a similar CPU from a second provider (e.g., Amazon).

For example, the initial budget for generating the avatar model may be $119 and the user may request a reduction by $19. The new budget is thus $100. Simplification module 104 may then determine the available computational resources that meet the requested budget. For example, costs 302 may list the individual fees for the available hardware. Simplification module 104 may select a specific hardware configuration that meets the budget. This process involves assessing the trade-offs between different hardware capabilities and their associated costs, ensuring that the selected configuration provides the necessary computational power to run the avatar model effectively, albeit with potential reductions in performance or visual quality to accommodate the budgetary limitations.

For example, there may be minimum requirements of a hardware configuration or computing device provided by a developer of the avatar model. There may also be specific user-requested characteristics that the user would like in the avatar model (e.g., a minimum polygon count). When searching for a hardware configuration, simplification module 104 may identify a configuration that meets the minimum requirements set by the developer and/or required by the user (e.g., a student in a class) and determine whether the configuration is less than or equal to the budget. If less than, simplification module 104 may then adjust the configuration (e.g., increase RAM) until the cost to run the avatar model is as close as possible to the budget without going over.

At 406, simplification module 104 executes a machine learning model (e.g., model 306) trained to select one or more of the visual characteristics and the movement capabilities of the avatar to adjust based on available computational resources and computational costs to utilize the available computational resources. For example, if the current hardware configuration is better than the newly selected hardware configuration (e.g., because the computational resources are limited due to a smaller budget), the model may reduce the resolution of the avatar's textures or simplify its animations.

In some aspects, the computational costs comprise a plurality of predefined weights for the machine learning model, wherein the weights are associated with the computational resources. More specifically, each respective weight of the plurality of weights may be indicative of a fee or tariff or micropayment for utilizing a corresponding computational resource of the computational resources. For example, if the price to run a particular GPU is $0.19 per minute, the weight may be 0.19 or a factor of 0.19. In some aspects, the weight may be a function of the fee. For example, if the function is 2x+1, the weight may be 2*0.19+1=1.38.

In some aspects, the machine learning model is trained to identify a bottleneck in avatar generation that has a highest computational cost and perform reduction on the bottleneck. By pinpointing these bottlenecks, the model can strategically perform reductions, such as simplifying complex animations or reducing the number of polygons in 3D models, thereby optimizing resource usage and minimizing costs. For example, if rendering high-detail facial expressions is identified as a bottleneck, the model may reduce the complexity of these expressions to free up computational resources for other tasks. The costs of each aspect of generating the avatar model may be stored in steps database 310. The machine learning model may thus prioritize certain simplifications over others.

In some aspects, the machine learning model is trained on a training dataset comprising a plurality of input computational cost changes and corresponding avatar adjustments. For example, the dataset may include cases where a reduction in available GPU power led to a decrease in frame rate, prompting the model to adjust the avatar's movement capabilities to maintain a seamless user experience. By leveraging this training, the model can dynamically adapt to changing resource conditions, ensuring that the avatar remains functional and visually appealing within the constraints of the available computational resources.

At 408, simplification module 104 adjusts the one or more of the visual characteristics and the movement capabilities of the avatar outputted by the machine learning model in response to the request. This adjustment process is crucial for maintaining a balance between performance/visual fidelity and the user budget, ensuring that the avatar remains functional and visually appealing even when the device's resources are limited due to the budget of the user. For instance, if the selected GPU is unable to handle high-resolution textures due to limited VRAM (where the user cannot afford a higher-end GPU due to financial constraints), simplification module 104 may reduce the texture quality or resolution of the avatar, thereby decreasing the graphical load without significantly compromising the overall appearance.

In some aspects, adjusting one or more of the visual characteristics and the movement capabilities of the avatar comprises performing one or more of: (1) decreasing active movements performed by the avatar, (2) reducing an amount of expressions performed by the avatar, (3) reducing a size of the avatar, (4) decreasing a rendering resolution of the avatar, (5) using prerecorded videos of gestures in place of dynamic animations performed by the avatar, or (6) reducing appearance details on the avatar.

In some aspects, reducing the appearance details on the avatar comprises one or more of: (1) changing dynamic elements of appearance to static, (2) deleting layers with reflections, (3) replacing a photo-realistic avatar with a cartoon avatar (e.g., as shown in FIG. 2), or (4) combining geometry likelihood layers.

In some aspects, the visual characteristics further comprise internal characteristics including one or more of: skeleton components and computational characteristics. For example, the computational characteristics include one or more of: an amount or size of physical models, Courant number, amount of hairs, amount of textures, and amount of polygons.

In some aspects, simplification module 104 may receive a subsequent request to increase the computational costs for generating the avatar by the specified amount (e.g., an increase in budget), and may re-adjust the one or more of the visual characteristics and the movement capabilities of the avatar outputted by the machine learning model in response to the subsequent request (e.g., because better computational resources are now affordable).

In some aspects, adjusting comprises resetting the one or more of the visual characteristics and the movement capabilities of the avatar outputted by the machine learning model without re-executing the machine learning model in response to determining that the specified amount is a same amount (e.g., $19) comprised in the request to reduce the computational costs.

In some aspects, simplification module 104 further receives user experience requirements associated with the avatar model. Accordingly, simplification module 104 evaluates (e.g., using user experience component 110) a quality of avatar generation and adjusts, based on the quality of avatar generation, one or more of the visual characteristics and the movement capabilities of the avatar while the avatar is displayed on the computing device.

In some aspects, evaluating the quality of the avatar generation comprises monitoring for user experience feedback generated based on interactions with the avatar. This feedback may be collected through various channels, such as user surveys, in-app ratings, or direct comments, providing valuable insights into how users perceive the avatar's performance and visual appeal. For instance, users may report on the avatar's responsiveness during interactions, noting whether movements appear smooth and natural or if there are noticeable lags or glitches. Additionally, feedback may highlight the visual fidelity of the avatar, such as the realism of textures and the accuracy of facial expressions, which are crucial for creating an engaging and immersive experience. By analyzing this feedback, module 104 may identify specific areas where the avatar excels or falls short, allowing them to make targeted improvements.

In some aspects, evaluating the quality of the avatar generation comprises comparing avatar performance against predetermined benchmarks. These benchmarks may serve as a set of standards or criteria that define the expected performance levels for various aspects of the avatar, such as visual fidelity, responsiveness, and interaction capabilities. For example, a benchmark may specify that the avatar should maintain a minimum frame rate of 60 frames per second to ensure smooth animations and transitions. By comparing the avatar's actual performance to these benchmarks, module 104 may objectively assess whether the avatar meets the desired quality standards. If the avatar falls short, such as displaying at only 30 frames per second, it indicates a need for optimization in rendering processes or resource allocation. Additionally, benchmarks may include criteria for latency in response to user inputs, ensuring that the avatar reacts within a specified time frame to maintain a seamless user experience. For instance, if the benchmark requires a response time of less than 100 milliseconds for user interactions, any delay beyond this threshold would highlight areas for improvement in the avatar's programming or network handling.

Ultimately, module 104 is configured to find a balance such that adjustments do not cause the avatar to dip below the minimal requirements for meeting user expectations/benchmarks, while ensuring that computational resources and channels are efficiently utilized based on availability and costs.

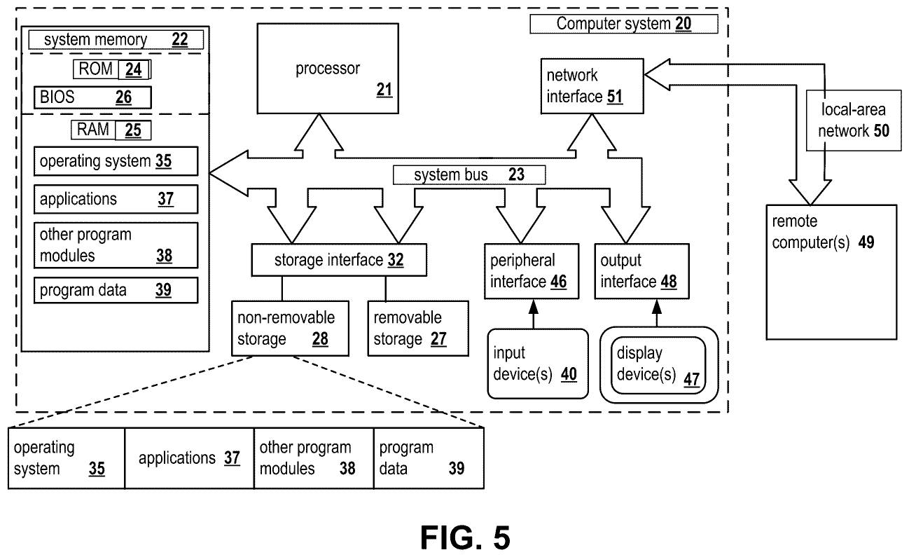

FIG. 5 is a block diagram illustrating a computer system 20 on which aspects of systems and methods for adjusting an avatar model on the fly may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for adjusting an avatar, the method comprising:
generating, for display on a computing device, an avatar based on an avatar model specifying visual characteristics and movement capabilities of the avatar;
receiving a request to reduce computational costs for generating the avatar by a specified amount;
executing a machine learning model trained to select one or more of the visual characteristics and the movement capabilities of the avatar to adjust based on available computational resources and computational costs to utilize the available computational resources; and
adjusting the one or more of the visual characteristics and the movement capabilities of the avatar outputted by the machine learning model in response to the request.

2. The method of claim 1, wherein the request to reduce the computational costs is for decreasing a total monetary cost to utilize of one or more of: central processing unit (CPU), graphics processing unit (GPU), random access memory (RAM), storage, bandwidth, latency, and validation resources.

3. The method of claim 2, wherein the total monetary cost is a dynamic value that changes based on one or more of: time of usage, location of usage, and type of provider.

4. The method of claim 1, wherein the machine learning model is trained to identify a bottleneck in avatar generation that has a highest computational cost and perform reduction on the bottleneck.

5. The method of claim 1, wherein the machine learning model is trained on a training dataset comprising a plurality of input computational cost changes and corresponding avatar adjustments.

6. The method of claim 1, further comprising:
receiving user experience requirements associated with the avatar model;
evaluating a quality of avatar generation; and
adjusting, based on both the quality of avatar generation and the request, one or more of the visual characteristics and the movement capabilities of the avatar while the avatar is displayed on the computing device.

7. The method of claim 6, wherein evaluating the quality of the avatar generation comprises monitoring for user experience feedback generated based on interactions with the avatar.

8. The method of claim 6, wherein evaluating the quality of the avatar generation comprises comparing avatar performance against predetermined benchmarks.

9. The method of claim 1, wherein the visual characteristics further comprise internal characteristics including one or more of: skeleton components and computational characteristics.

10. The method of claim 9, wherein the computational characteristics include one or more of: an amount or size of physical models, Courant number, amount of hairs, amount of textures, amount of polygons.

11. The method of claim 1, wherein adjusting one or more of the visual characteristics and the movement capabilities of the avatar comprises performing one or more of:
(1) decreasing active movements performed by the avatar,
(2) reducing an amount of expressions performed by the avatar,
(3) reducing a size of the avatar,
(4) decreasing a rendering resolution of the avatar,
(5) using prerecorded videos of gestures in place of dynamic animations performed by the avatar, or
(6) reducing appearance details on the avatar.

12. The method of claim 11, wherein reducing the appearance details on the avatar comprises one or more of:
(1) changing dynamic elements of appearance to static,
(2) deleting layers with reflections
(3) replacing a photo-realistic avatar with a cartoon avatar, or
(4) combining geometry likelihood layers.

13. The method of claim 1, further comprising:
receiving a subsequent request to increase the computational costs for generating the avatar by the specified amount;
re-adjusting the one or more of the visual characteristics and the movement capabilities of the avatar outputted by the machine learning model in response to the subsequent request.

14. The method of claim 13, wherein re-adjusting comprises resetting the one or more of the visual characteristics and the movement capabilities of the avatar outputted by the machine learning model without re-executing the machine learning model in response to determining that the specified amount is a same amount comprised in the request to reduce the computational costs.

15. The method of claim 1, wherein the computational costs comprise a plurality of predefined weights associated with the computational resources, wherein each respective weight of the plurality of weights is indicative of a fee for utilizing a corresponding computational resource of the computational resources.

16. A system for adjusting an avatar, comprising:
at least one memory; and
at least one hardware processor coupled with the at least one memory and configured, individually or in combination, to:
generate, for display on a computing device, an avatar based on an avatar model specifying visual characteristics and movement capabilities of the avatar;
receive a request to reduce computational costs for generating the avatar by a specified amount;
execute a machine learning model trained to select one or more of the visual characteristics and the movement capabilities of the avatar to adjust based on available computational resources and computational costs to utilize the available computational resources; and
adjust the one or more of the visual characteristics and the movement capabilities of the avatar outputted by the machine learning model in response to the request.

17. The system of claim 16, wherein the request to reduce the computational costs is for decreasing a total monetary cost to utilize of one or more of: central processing unit (CPU), graphics processing unit (GPU), random access memory (RAM), storage, bandwidth, latency, and validation resources.

18. The system of claim 17, wherein the total monetary cost is a dynamic value that changes based on one or more of: time of usage, location of usage, and type of provider.

19. The system of claim 16, wherein the machine learning model is trained to identify a bottleneck in avatar generation that has a highest computational cost and perform reduction on the bottleneck.

20. The system of claim 16, wherein the machine learning model is trained on a training dataset comprising a plurality of input computational cost changes and corresponding avatar adjustments.

21. A non-transitory computer readable medium storing thereon computer executable instructions for adjusting an avatar, including instructions for:
generating, for display on a computing device, an avatar based on an avatar model specifying visual characteristics and movement capabilities of the avatar;
receiving a request to reduce computational costs for generating the avatar by a specified amount;
executing a machine learning model trained to select one or more of the visual characteristics and the movement capabilities of the avatar to adjust based on available computational resources and computational costs to utilize the available computational resources; and
adjusting the one or more of the visual characteristics and the movement capabilities of the avatar outputted by the machine learning model in response to the request.
